(19) United States
(12) Patent Application Publication
(10) Pub. No.: US 2013/0125040 A1
(43) Pub. Date: May 16, 2013

(54) Interstitial navigation panel for navigating data representing content and applications

(71) Applicant: Laura Marie Smith, San Francisco, CA (US)

(72) Inventor: Laura Marie Smith, San Francisco, CA (US)

(73) Assignee: Adobe Systems Incorporated, San Jose, CA (US)

(21) Appl. No.: 11/633,310

(22) Filed: Dec. 4, 2006

(51) Int. Cl. G06F 3/048

(52) U.S. Cl. CPC G06F 3/048
USPC 715/781

(57) ABSTRACT

Embodiments of the invention relate generally to an interstitial panel in an interface for navigating content. In various embodiments, methods and computer readable media can render content in response to selections in navigational panels without transitioning away from content in a content panel. In one embodiment, a method includes rendering content from multiple sources of content in a first interface portion, presenting a representation in a second interface portion for a pool of content that forms a subset of the multiple sources of the content, and presenting descriptors in a third interface portion for the pool of content. Presenting the representation and the descriptors can occur simultaneous (or nearly simultaneous) to rendering of the content from the multiple sources. In another embodiment, the first, second, and third interface portions can include a content panel, an application navigation panel and an interstitial navigation panel.

### FIELD OF THE INVENTION

Embodiments of the invention relates generally to computing devices and systems, software, computer programs, applications, and user interfaces, and more particularly, to implementing an interstitial panel for navigating content.

### BACKGROUND OF THE INVENTION

Searching for information in large networks (e.g., the Internet) and in sophisticated databases or software programs is often a difficult task. Typically, searchers resort to trial and error techniques to find information. The hunt for relevant information is further impeded by window presentation schemes that are used to convey search results. For example, one conventional window presentation scheme might require a user to open and close a large number of windows to sift through intervening windows containing search results and windows containing information or content. Often times, the later-opened windows obscure the previously-opened windows. In another scheme, a traditional interface might require a searcher to repetitively transition between search results and information (from a selected search result) within the same window. A drawback inherent in these window presentation schemes is that selected information or content in a window usually obscures the context of the search (e.g., the search results), thereby disrupting a searcher's ability to efficiently navigate sources of information.

FIG. 1 depicts an interface 100 implementing a common window presentation scheme for traditional search techniques. In a typical search, a window 102 is presented to a searcher in response to certain search criteria, the entry of which is not shown. Window 102 includes the following search results: search result (“Result 1”) 104, search result (“Result 2”) 106, and search result (“Result 3”) 108. As FIG. 1 shows, window 102 transitions to window 112 when the searcher selects search result 104. If the search is dissatisfied with the information in window 112, the searcher transitions back to window 102. This back-and-forth navigation process continues between window 102 and window 122 as well as between window 102 and window 132 until the searcher in this example is satisfied that the information (i.e., “content 3”) in window 132 is relevant. In some window presentation schemes, windows 102, 112, 122, and 132 are different windows, whereas in other schemes they are the same window. Therefore, current window presentation schemes often require a searcher to experience numerous transitions between search results and content. This, in turn, hinders the search process.

It would be desirable to provide improved techniques, systems and devices that minimize one or more of the drawbacks associated with conventional techniques for navigating content.

### BRIEF DESCRIPTION OF THE FIGURES

The invention and its various embodiments are more fully appreciated in connection with the following detailed description taken in conjunction with the accompanying drawings, in which:

FIG. 1 depicts an interface implementing a common window presentation scheme for traditional search techniques;

FIG. 2 is a functional diagram of an interface implementing one or more interface portions to navigate content and one or more other portions to render content, according to at least one embodiment of the invention;

FIG. 3 is an example of an interface implementing one or more navigation panels and at least one content panel, according to an embodiment of the invention;

FIGS. 4A to 4C depict an example of an interface implementing a content panel, an application navigation panel, and an interstitial navigation panel, according to one or more embodiments of the invention;

FIGS. 5A and 5B illustrate other examples of interfaces, according to other alternative embodiments of the invention;

FIGS. 6A and 6B are flow diagrams depicting examples of methods for navigating content, according to various embodiments of the invention;

FIGS. 7A and 7B illustrate examples of panel presentation application for navigating content, according to various embodiments of the invention;

FIG. 8 illustrates an exemplary computer system suitable for implementing panel presentation for navigating content in an interface, according to at least one embodiment of the invention; and

FIG. 9 illustrates an example of a panel presentation system for navigating content in conjunction with an interface.

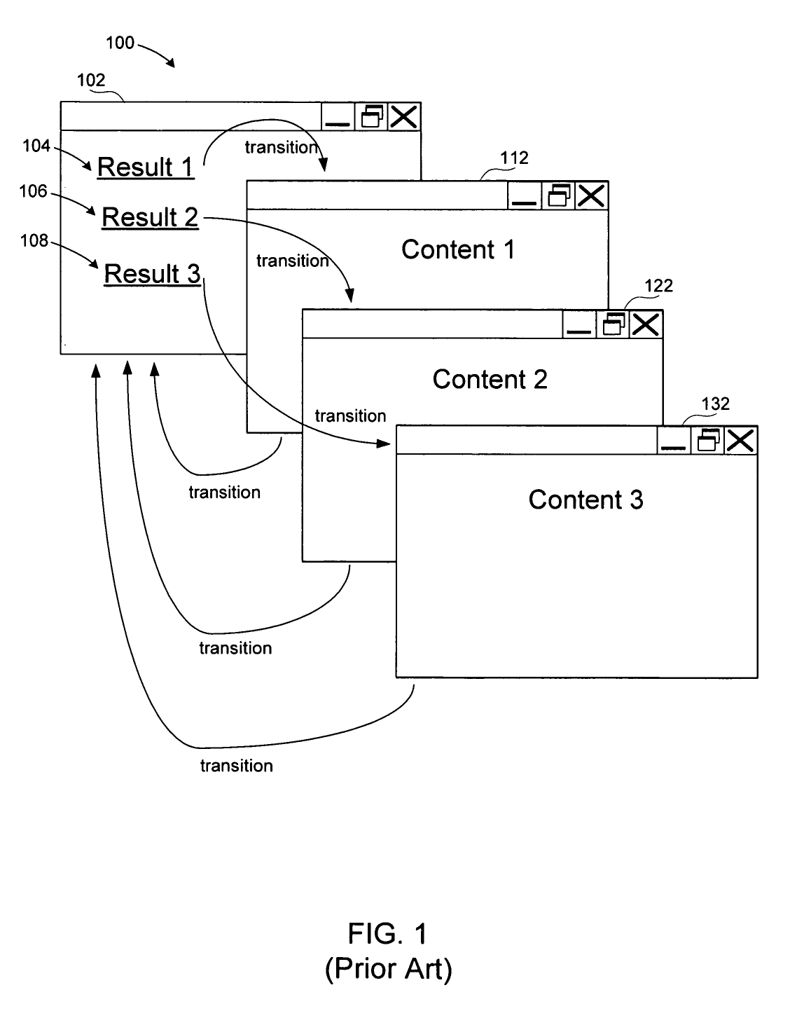

Like reference numerals refer to corresponding parts throughout the several views of the drawings. Note that most of the reference numerals include one or two left-most digits that generally identify the figure that first introduces that reference number.

### DETAILED DESCRIPTION

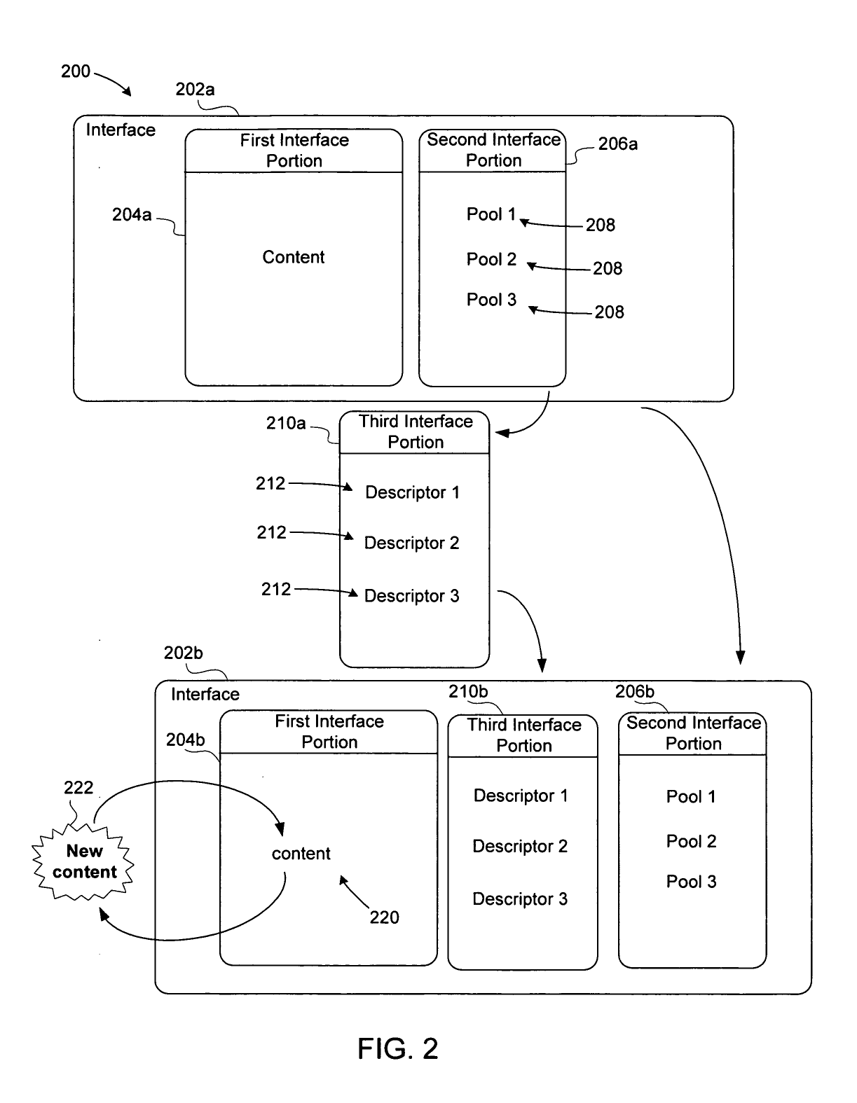

FIG. 2 is a functional diagram 200 of an interface implementing one or more interface portions to navigate content, and one or more other portions to display content, according to at least one embodiment of the invention. In the example shown, interface 202a can include a first interface portion 204a configured to render content from multiple sources of content, and a second interface portion 206a configured to present pools of content. Second interface portion 206a is shown to include representations for each of pools of content 208, such as “Pool 1,” “Pool 2,” and “Pool 3.” A user navigates through the pools of content 208 by, for example, selecting a specific representation, such as Pool 2. The selection of the representation can be made in response to a user gesture, such as a mouse click or any other input received via an input/output device (not shown). Upon detecting the selection of a representation (e.g., Pool 2), interface 202a then includes a third interface portion 210a to form interface 202b. Third interface portion 210a is configured to present descriptors 212, which identify the sources of content associated with a selected pool of content. When a user selects one of descriptors 212, different content (“new content”) 222 from a different source of content can be rendered in first interface portion 204b.

The inclusion of third interface portion 210b in interface 202b, therefore, can facilitate the presentation of the representations for both the pools of content and the descriptors simultaneous to, or nearly (i.e., substantially) simultaneous to, the rendering of content 220 from multiple sources. In some cases, interface 202b can render content from any number of sources of content while presenting second interface portion 206b and third interface portion 210b without significant interruption. According to one embodiment, third interface portion 210b—alone or in cooperation with second interface portion 206b—enables content 220 in first interface portion 204b to transition directly from a first source of content to other content (“new content”) 222 from a second source of content. In another embodiment, first interface portion 204b transitions between content from different sources of content without presenting either representations for pools of content 208 or descriptors 212, or both.

In view of the foregoing, a user can navigate through different content without transitioning between two or more panels, such as between a panel presenting search results and a panel rendering content, while searching for relevant content. As such, a searcher using interface 202b can experience (e.g., either visually or aurally, or both) content without losing the context in which the navigation is occurring (i.e., the presentation of descriptors 212 and pools of content 208 remain available and/or unobscured). Further, interface 202b allows users to search through a list of results, such as presented in one or more interface portions, and preview content in at least one other interface portion. Thus, the searcher can scan content and/or search results without leaving the web page or panel that they are currently viewing to transition to an intervening panel, which includes search information rather than content. Moreover, the searcher can maintain access to content while pools of content or descriptors change in later queries.

As used herein, the term “content,” at least in one embodiment, refers to information and/or material presented to a user on an interface in relation to a web site or an application, such as a software product. Content can also include the audio and/or visual presentation of text, such as an electronic document (e.g., a document in Portable Document Format (“PDF”)), as well as audio files, images, audio/video media, such as Flash presentations, and the like. As used herein, the term “source of content,” at least in one embodiment, refers to a content file, which is a file including data representing content, such as a JPG file or an MP3 file, and to any entity that sources content, such as one or more networked computers. As used herein, the term “pool of content,” at least in one embodiment, refers to content or multiple sources of content that share at least one characteristic, which is used to categorize the content. For example, a pool of electronic documents can include PDF documents having a tag “item renderer.”

As used herein, the term “representation,” at least in one embodiment, refers to data representing words, letters, numbers, symbols, images, etc., any of which can describe a pool of content and form an association therewith. In some cases, a representation is selectable such that when it is selected, an associated pool of content (or its descriptors) is presented. In one embodiment, a representation is a link. As used herein, the term “descriptor,” at least in one embodiment, refers to data representing words, letters, numbers, symbols, images, etc., any of which can describe a pool of content and form an association therewith. In some cases, a descriptor is selectable such that when it is selected, a source of content is rendered. In one embodiment, a representation is a link (e.g., a hyperlink) to a certain source of content, such as a PDF document.

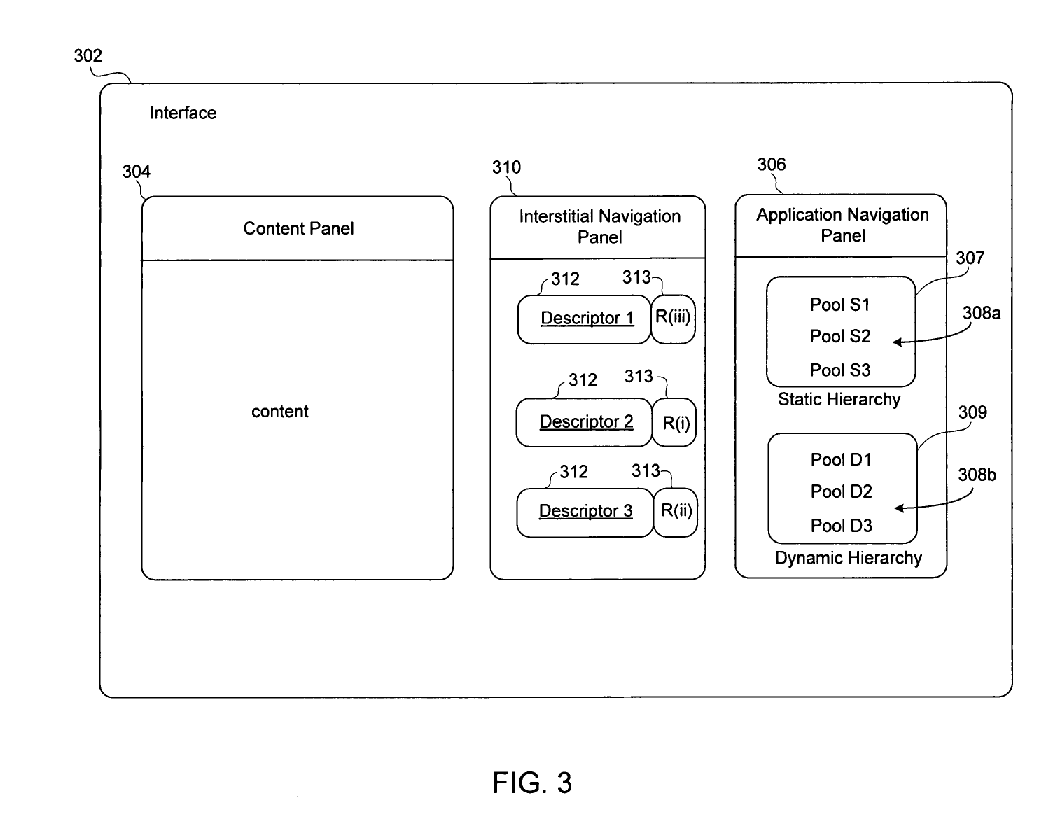

FIG. 3 is an example of an interface implementing one or more navigation panels and at least one content panel, according to an embodiment of the invention. As shown, interface 302 can include a content panel 304 for rendering content, an application navigation panel 306 for navigating through pools of content, and an interstitial navigation panel 310 for navigating through individual sources of content. In at least one embodiment, content panel 304, application navigation panel 306, and interstitial navigation panel 310 are functionally equivalent to the first, second and third interface portions, respectively, of FIG. 2. As used herein, the term “panel,” at least in one embodiment, can refer to displays, palettes, tabs, windows, screens, portions of an interface, and the like.

In one embodiment, application navigation panel 306 includes pools of content arranged in a static hierarchy or a dynamic hierarchy. In the example shown, a first group 307 arranges pools of content 308a in a static hierarchical arrangement with respect to each other. For example, pools of content 308a each can be associated with representations, such as “Pool S1,” “Pool S2,” and “Pool S3,” whereby each pool represents a folder in a static hierarchical arrangement with respect to other representations as other folders. In such a static hierarchy, descriptors 312 can also be statically arranged as files in the folders of application navigation panel 306. As used herein, the term “static hierarchy,” at least in one embodiment, refers to a fixed taxonomy of either pools of content 308a (or representations thereof) or descriptors 312 (or sources of content). Generally, the elements of a fixed taxonomy are categorically arranged with respect to each other in terms of a specific characteristic, rather than relevancy to users. In some instances, the arrangement of elements in a fixed taxonomy is determined by, for example, the owner of content without regard to feedback from one or more users.

In another example, application navigation panel 306 can also include a second group 309 of content pools. The pools of content 308b in second group 309 are arranged in accordance with a dynamic hierarchy. Each pool of content 308b can be associated with a representation, such as “Pool D1,” “Pool D2,” or “Pool D3.” As used herein, the term “dynamic hierarchy,” at least in one embodiment, refers to a dynamic arrangement of either pools of content 308b or descriptors 312, or both. Generally, the elements of a dynamic hierarchy are arranged with respect to each other—in whole or in part—in accordance to a degree of relevancy the content has to users. In some instances, the degree of relevancy for each pool or source of content is determined by aggregating, for example, feedback from one or more users, such as a community of users. As such, the degree of relevancy is a quantifiable measure of value that a source of content has for a community of users.

As is shown, interstitial navigation panel 310 includes descriptors 312 relating to sources of content that collectively constitute a selected pool of content. Each descriptor 312 includes, or is associated with, a representation 313 that indicates a degree of relevancy for a source of content. In some embodiments, the degree of relevancy includes a ranking, a weighting, a date, or any other indicia that conveys the relative importance of a source of content in relation to others. Note that descriptors 312 can be arranged in accordance with a static hierarchy, if one of the pools of content 308a is selected, or with a dynamic hierarchy, if any of pools of content 308b is chosen.

Representations for pools of content 308a and 308b can be selectable such that when selected, an associated pool of content (or its descriptors) is presented in interstitial navigation panel 310. In one embodiment, application navigation panel 306 presents tags as representations for pools of content 308a and 308b. In some instances, a tag for the pools of content 308a and 308b can be ranked differently than other tags. Interstitial navigation panel 310 includes descriptors 312, which also can be selectable. In one embodiment, descriptors 312 are links, such as hyperlinks, to sources of content. As used herein, the term “tag,” at least in one embodiment, refers to metadata associated with a source of content, such as an electronic document, that provides information about the source of content. For example, a tag can be any word, such as a keyword, symbol, image, etc. Typically, an author of content attaches one or more tags to a piece of content to describe the content and/or make the content more readily searchable. For instance, photographers might attach a tag “tree” to digital photos depicting a forest.

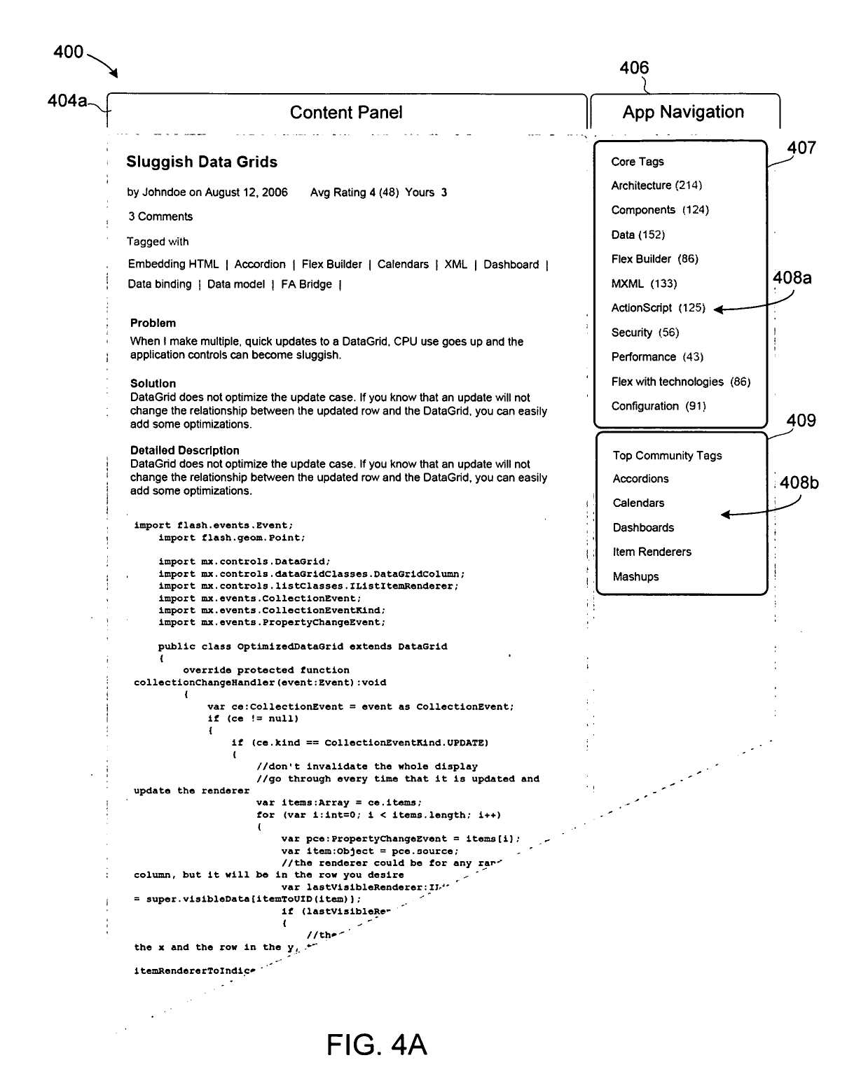

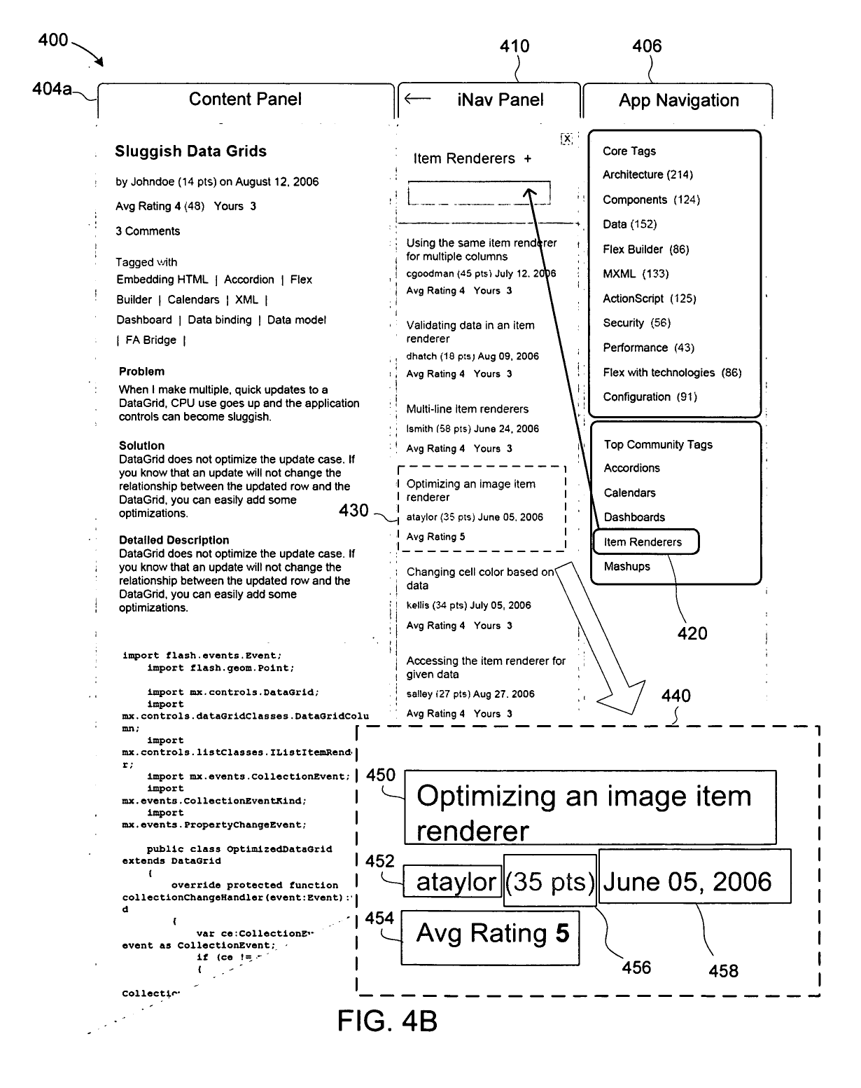

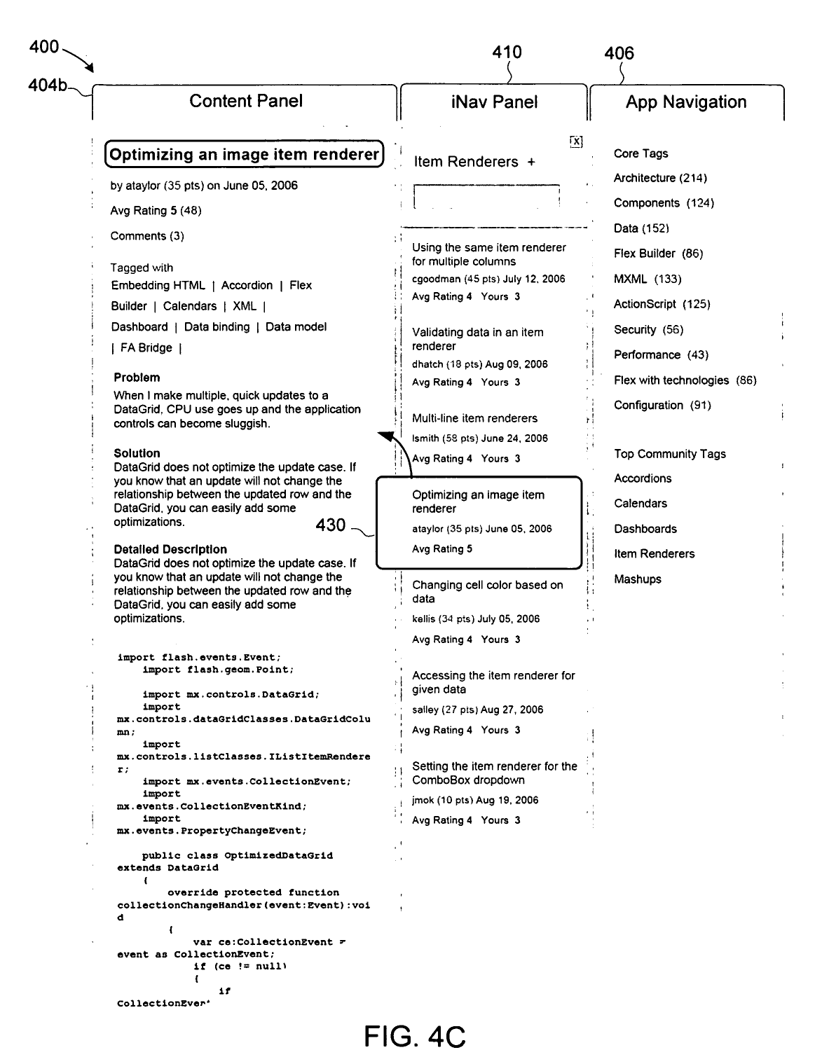

FIGS. 4A to 4C depict an example of an interface implementing a content panel, an application navigation panel, and an interstitial navigation panel, according to one or more embodiments of the invention. FIG. 4A shows interface 400 presenting a content panel 404a and an application navigation panel (“app navigation”) 406. Here, content panel 404a presents content having a title “Sluggish Data Grids.” Application navigation panel 406 includes a first group of tags 407. Tags 408a in group 407 are “core tags,” which have been identified as important tags (e.g., by an owner of a web site) and arranged in accordance with a static hierarchy. By contrast, a second group of tags 409 include, for example, user-defined tags attributed to sources of content. Tags 408b are community tags arranged in a dynamic hierarchy based on, for example, rankings attributed to tags 408b. In this example, the tags “accordions,” “calendars,” “dashboards,” “item renders” and “mashups” are highly ranked tags based on input from one or more users.

FIG. 4B shows interface 400 presenting interstitial navigation panel (“iNav panel”) 410 in response to a selection of a tag in application navigation panel 406. In particular, the selection of tag 420 causes interstitial navigation panel 410 to form, for example, between content panel 404a and application navigation panel 406. Tag 420 is associated with a pool of content, each of which has been tagged with the tag “item renderers.” Interstitial navigation panel 410 includes a number of descriptors 430. In one embodiment, each descriptor 430 includes one or more descriptors, which can include indicia of one or more degrees of relevancy. For example, as inset 440 shows, descriptor 430 can include a title 450, a person's name (e.g., an author) 452, and date 458, which can be used to determine relevancy. Further, descriptor 430 can include—as indicia of relevancy—representations 454 and 456. Representation 454 can include a rating given by either a subset of select users, or only the user that selected tag 408b. Representation 456 can indicate a ranking (e.g., total points) given by a community. Any of the forgoing in descriptor 430 can be selectable. Further, more or fewer descriptors can be included in descriptor 430. In at least one embodiment, each selection of a specific descriptor 430 in a dynamic hierarchical arrangement can be fed back to either logic or a processor to modify the selection's relevancy in response to its selection.

FIG. 4C shows interface 400 switching directly to other content in content panel 404a without a transition to an intervening panel. As shown, descriptor 430 is selected, which, in turn, causes content titled “Optimizing an image item renderer” to be rendered in content panel 404a. Notably, new content is rendered while maintaining the context of the search. That is, interstitial navigation panel 410 and application navigation panel 406 remain visible and relatively unaltered, if at all. Consequently, a user can cycle through content by selecting different descriptors 430 without losing time or context due to transitions to intervening panels that present information other than content.

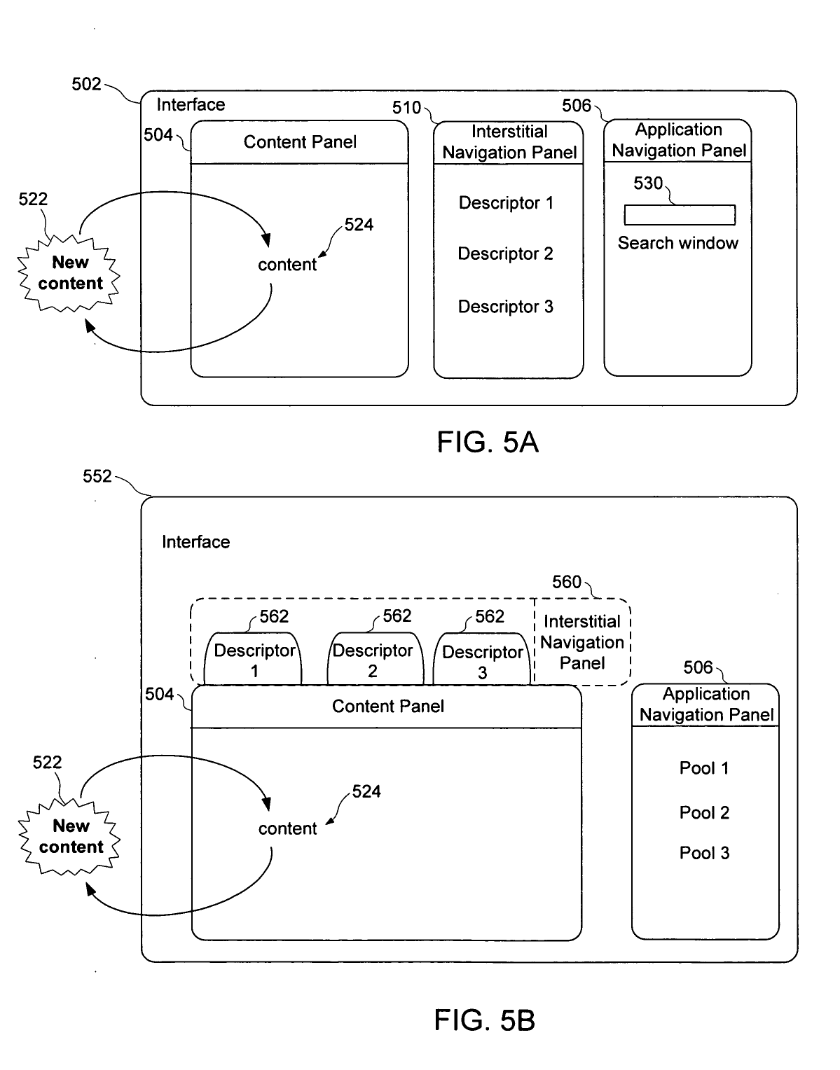

FIGS. 5A and 5B illustrate other examples of interfaces, according to other alternative embodiments of the invention. FIG. 5A depicts an interface 502 including a content panel 504, an application navigation panel 506, and an interstitial navigation panel 510. In this example, application navigation panel 506 includes a search field 530 for receiving user input (i.e., search criteria), such as key search words. Interstitial navigation panel 510 can be formed in response to a search entered into search field 530, and can include links as descriptors. Thus, the descriptors can be the search results derived from a search performed in application navigation panel 506. The selection of those links enables content 524 to change to new content 522 while maintaining application navigation panel 506 and interstitial navigation panel 510.

FIG. 5B depicts an interface 552 including a content panel 504 for cycling through the presentation of content 524 and new content 522, as well as an application navigation panel 506 and an interstitial navigation panel 560. In this example, a collection of tabs 562 constitute interstitial navigation panel 560. Each tab 562 can include a descriptor. As used herein, the term “interstitial,” at least in one embodiment, can refer to a panel positioned in an intervening space between a content panel and an application navigation panel in an interface. The term “interstitial” can also refer to any display (or portion thereof), palette, tab, window, screen, portion of an interface, and the like, that presents intermediary search results, such as descriptors, to facilitate switching of content 524 with content 522 without intervening panels or information that do not include content.

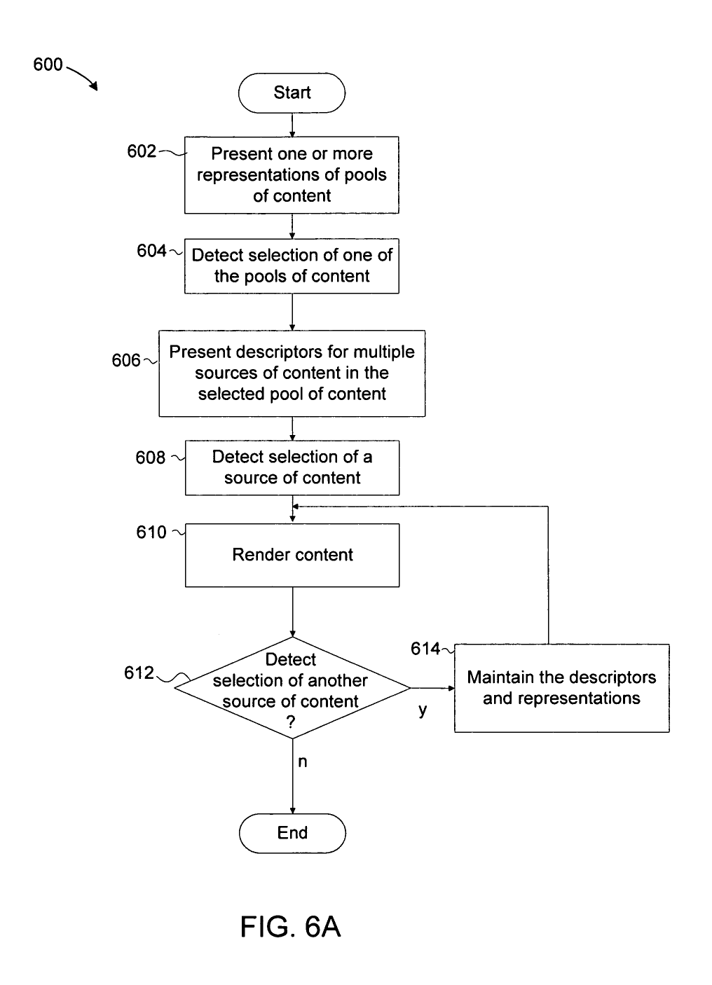

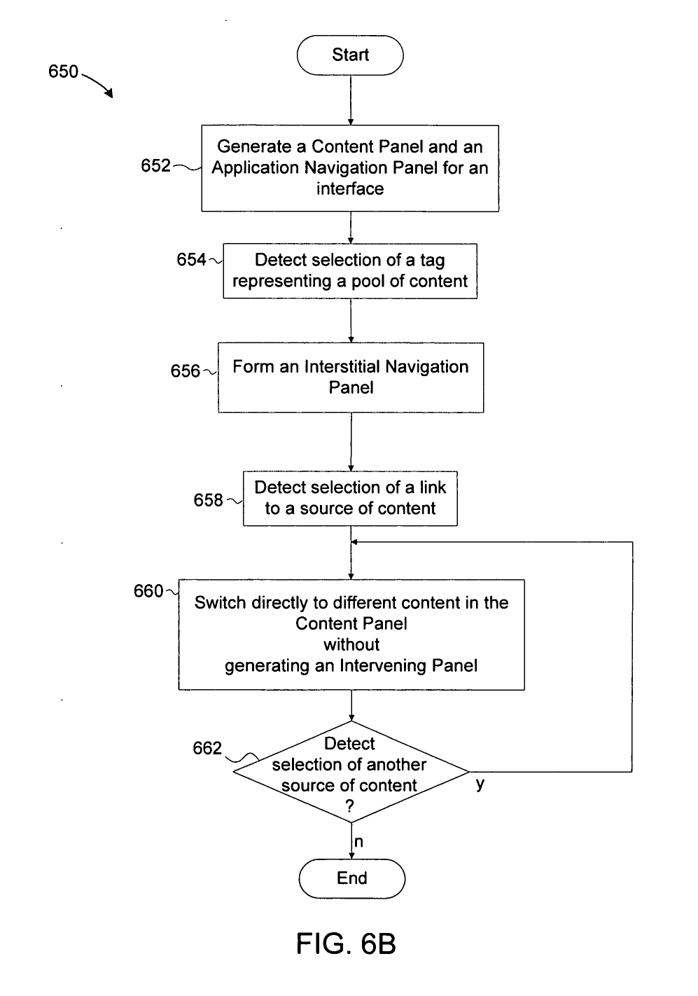

FIG. 6A is a flow diagram depicting one example of a method for navigating content, according to one embodiment of the invention. As shown, flow 600 begins at 602, at which an interface, a processor, an application and/or logic, for example, presents one or more representations, such as tags, for pools of content. Flow 600 detects a selection of one of the pools of content at 604, and, in response, presents descriptors for multiple sources of content on an interface at 606. Upon detecting a selection of a source of content (or an associated descriptor) at 608, flow 600 continues to 610 at which content is rendered. At 612, flow 600 determines whether another source of content has been selected. If so, other content is rendered at 610 while maintaining descriptors and representations at 614. Otherwise, flow 600 terminates.

FIG. 6B is a flow diagram depicting another example of a method for navigating content, according to one embodiment of the invention. As shown, flow 650 begins at 652, at which an interface, a processor, an application and/or logic, for example, generates a content panel and an application panel. Flow 650 provides for the detection of a tag representing a pool of content at 654, and, in response, an interstitial navigation panel, including links, is formed at 656. Upon detecting a selection of a link to a source of content at 658, flow 650 continues to 660 at which content in the content panel is directly switched to different content without generating an intervening panel. At 662, flow 650 determines whether another source of content has been selected. If so, other content is switched in at 660. Otherwise, flow 650 terminates.

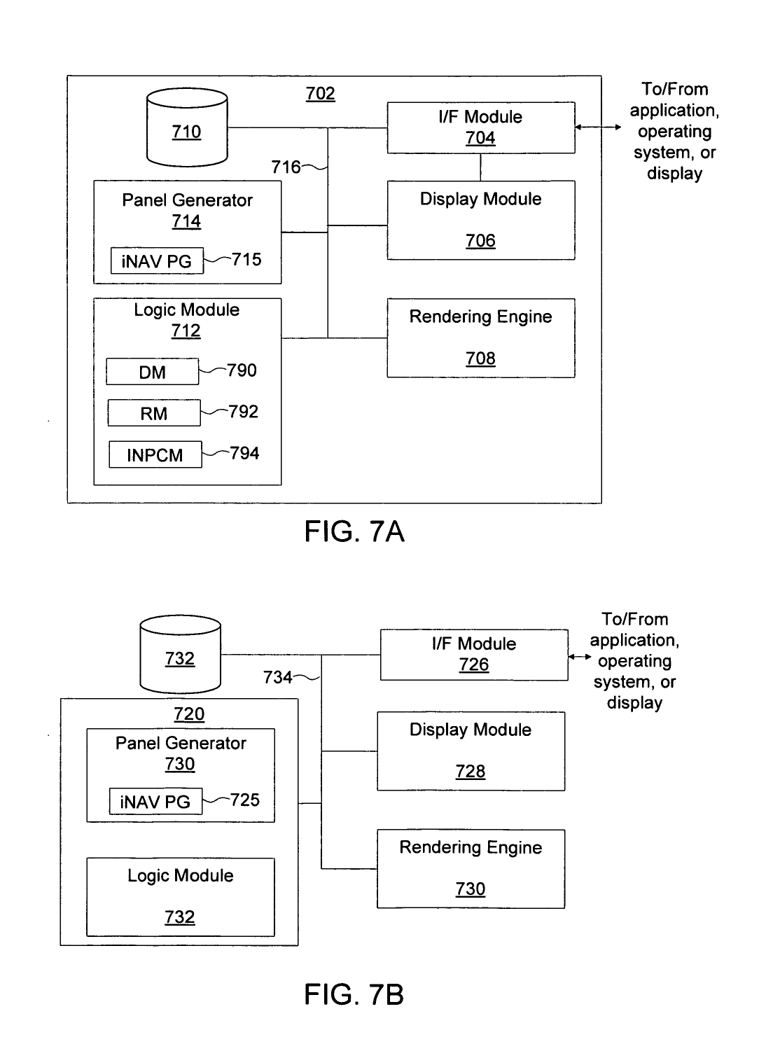

FIG. 7A illustrates an example of panel presentation application for navigating content, according to various embodiments of the invention. Here, application 702 includes interface (“I/F”) module 704, display module 706, rendering engine 708, repository 710, logic module 712, panel generator 714, and data bus 716. In some examples, the number and type of elements shown and described may be varied and are not limited to the descriptions provided. In some examples, the above-described elements can be implemented as part, component, or module of application 702. As an example, application 702 can be implemented as either a web browser or as a search tool for a software product, and can have panel presentation and content navigation functionality implemented as part of application 702. Logic module 712 can be implemented as software, hardware, circuitry, or a combination thereof to implement control logic for the described techniques for panel presentation.

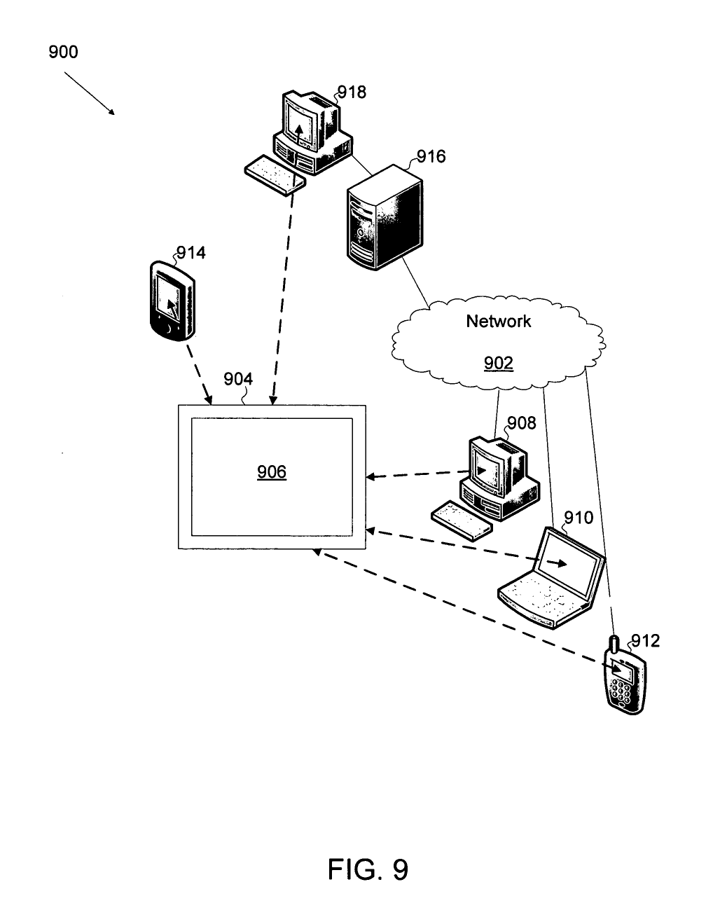

In some examples, logic module 712 can be configured to control panel generator 714 to form content panels, application navigation panel, and interstitial navigation panels. Rendering engine 708 can be configured to as a layout engine for web pages, for example, to manipulate both content (e.g., as expressed in or including HTML, XML, image files, etc.) and formatting information (e.g., as expressed in or including CSS, XSL, etc.) for rendering the data or information as one or more panels on interface 906 (FIG. 9). Interface module 704 can exchange panel presentation data, including content data, relevancy data, as well as other data, between application 702 and another application (e.g., a host, client, web services-based, distributed (i.e., enterprise), application programming interface (“API”), operating system, program, procedure or others) that can use data and information generated from panel generator 714 to render presented panels on a display screen. In other examples, the above-described techniques and elements can be varied in design, implementation, and function and are not limited to the descriptions provided.

In one embodiment, logic module 712 can include a detection module (“DM”) 790, a relevancy module (“RM”) 792, and an interstitial navigation panel control module (“INPCM”) 794. Detection module 790 is configured to detect selections of pools of content and/or descriptors by decoding, for example, a user's input, regardless of whether the selection is performed with a mouse or search criteria entered into a search field. Relevancy module 792 is configured to manage the degrees of relevancy for sources of content by obtaining data representing a degree of relevancy for modification or presentation purposes. For example, relevancy module 792 can manage a dynamic hierarchy in, for example, stored repository 710 or external to application 702. Interstitial navigation panel control module 790 can be configured to form an interstitial navigation panel by controlling interstitial navigation panel generator module (“iNAV PG”) 715, thereby controlling the rendering of content in the content panel.

FIG. 7B illustrates an alternative example for navigating content, according to one embodiment of the invention. Here, application 720 includes panel generator 722 and logic module 724, which can have equivalent functionality as 712 of FIG. 7A. Further, application 720 is shown in data communication with interface (“I/F”) module 726, display module 728, rendering engine 730, and repository 732. Data bus 734 can be configured to send or receive data among application 720, I/F module 726, display module 728, rendering engine 730, and repository 732. In other examples, more, fewer or different elements can be used and implemented without limitation to the examples provided above.

In some examples, logic module 724 and panel generator 722 can be implemented as part of application 720, which can be implemented separately from other functional components or modules, such as interface module 726, display module 728, rendering module 730, and repository 732. Data bus 734 can be implemented to communicate data over a given port between application 720 and interface module 726, display module 728, rendering module 730, and repository 732. In other words, application 720 can be implemented as a standalone application or as a component (i.e., module) of another application. Data or information (e.g., representations, tags, descriptors, links, and hierarchical relationships) associated with a panel can be stored in repository 732, which can be implemented using a database, data store, data warehouse, or any other type of data repository or structure. In other examples, more, fewer, or different modules can be used to implement the described techniques for panel presentation and are not limited to those provided.

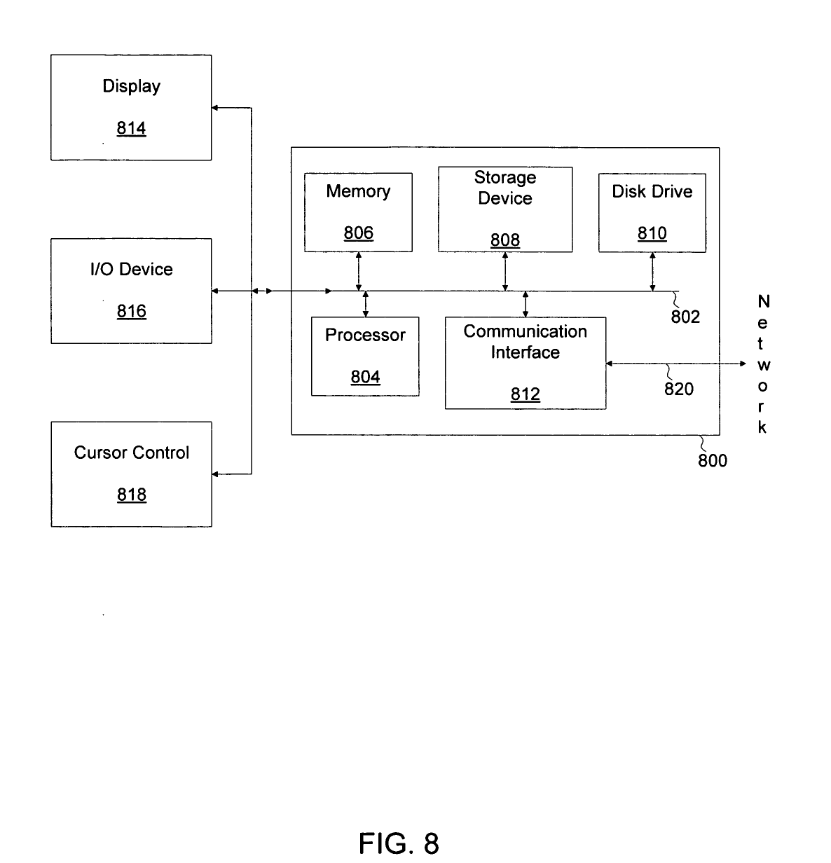

FIG. 8 illustrates an exemplary computer system suitable for implementing panel presentation for navigating content in an interface, according to at least one embodiment of the invention. In some examples, computer system 800 can be used to implement computer programs, applications, methods, processes, or other software to perform the above-described techniques and to realize the structures described herein. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to some examples, computer system 800 performs specific operations by processor 804 executing one or more sequences of one or more instructions stored in system memory 806. Such instructions can be read into system memory 806 from another computer readable medium, such as static storage device 808 or disk drive 810. In some examples, hard-wired circuitry can be used in place of or in combination with software instructions for implementation.

The term “computer readable medium” refers to any medium that participates in providing instructions to processor 804 for execution. Such a medium can take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions can be performed by a single computer system 800. According to some examples, two or more computer systems 800 coupled by communication link 820 (e.g., LAN, PSTN, or wireless network) can perform the sequence of instructions in coordination with one another. Computer system 800 can transmit and receive messages, data, and instructions, including program, i.e., application code, through communication link 820 and communication interface 812. Received program code can be executed by processor 804 as it is received, and/or stored in disk drive 810, or other non-volatile storage for later execution.

FIG. 9 illustrates an example of panel presentation system for navigating content using an interface. Here, system 900 includes network 902, display environment 904, interface 906, which can be presented on devices such as computer 908, notebook computer (“notebook” or “laptop”) 910, smart phone 912, personal digital assistant (“PDA”) 914, server 916, and administrator computer 918. In other examples, the number and type of devices can be varied and are not limited to those shown and described.

In some examples, navigation and content panels can be presented on interface 906, which can be an interface for an application such as a web browsing program, shopping website, Internet content portal, client or desktop application for any purpose. Panels can be used to provide additional or supplemental information that can be contextually relevant to another panel presented in interface 906. Computer 908, notebook computer (“notebook” or “laptop”) 910, smart phone 912, personal digital assistant (“PDA”) 914, server 916, and administrator computer 918 can provide content data for rendering content as well as relevancy data, which are used to hierarchically present tags and links in interface 906. In some cases, an operating system installed on computer 908 can communicate (i.e., via an application programming interface (“API”)) content data and/or relevancy data to another application installed on computer 908 to render (i.e., interpreting data and information to draw or display the content in an interface) one or more panels presented in interface 906. In some examples, different types of panels can be rendered in interface 906. In one embodiment, interface 906 can include any number and/or any type of display environments, such as CRT and LCD displays. Note that the above-described system and elements can be varied and are not limited to the descriptions or examples provided.

In at least some of the embodiments of the invention, the structures and/or functions of any of the above-described interfaces and panels can be implemented in software, hardware, firmware, circuitry, or a combination thereof. Note that the structures and constituent elements shown in FIGS. 7A to 9, as well as their functionality, can be aggregated with one or more other structures or elements. Alternatively, the elements and their functionality can be subdivided into constituent sub-elements, if any. As software, the above-described described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments.

Thus, the foregoing descriptions of specific embodiments of the invention are presented for purposes of illustration and description. They are not intended to be exhaustive or to limit the invention to the precise forms disclosed; many alternatives, modifications, equivalents, and variations are possible in view of the above teachings. For the purpose of clarity, technical material that is known in the technical fields related to the embodiments has not been described in detail to avoid unnecessarily obscuring the description. Thus, the various embodiments can be modified within the scope and equivalents of the appended claims. Further, the embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and their equivalents define the scope of the invention.

1. A method comprising:
using a computer to perform:
rendering content from multiple sources of content in a first portion of an interface;
presenting a plurality of representations in a second portion of said interface for a plurality of pools of content, wherein each one of the plurality of representations represents a different respective one of the plurality of pools of content, wherein each one of the plurality of pools of content forms a subset of said multiple sources of said content, and wherein the plurality of pools of content are part of a hierarchy within a domain of a single website;
presenting descriptors in a third portion of said interface corresponding to a selected representation for a respective pool of content, wherein presenting said representation and said descriptors occurs substantially simultaneous to rendering of said content from said multiple sources; and
in response to selection in said second portion of another representation for another respective pool of content, replacing said descriptors in said third portion with new descriptors corresponding to the selected another representation for the another respective pool of content, wherein the same rendered content remains displayed in said first portion when said descriptors are replaced with said new descriptors.

2. The method of claim 1 wherein rendering said content comprises transitioning directly from content from a first source of content to other content from a second source of content.

3. The method of claim 1 wherein rendering said content comprises transitioning between content from different sources of content without presenting either said representation or said descriptors, or both, in said first portion of said interface.

4. The method of claim 1 wherein rendering said content comprises:
rendering different content from different sources of content in said first portion of said interface; and
presenting said second portion and said third portion of said interface without interruption during rendering said different content.

5. The method of claim 1 wherein presenting said descriptors comprises:
detecting selection of said representation; and
generating said third portion of said interface in response to detecting said selection of said representation.

6. The method of claim 1 wherein presenting said descriptors comprises:
forming said third portion of said interface in between said first portion and said second portion of said interface.

7. The method of claim 1 further comprising:
detecting selection of a descriptor from said descriptors; and
rendering other content in said first portion of said interface in response to said selection of said descriptor.

8. The method of claim 1 further comprises:
arranging said plurality of pools of content in a dynamic hierarchical arrangement.

9. The method of claim 1 further comprises:
arranging at least one of said descriptors in a dynamic hierarchical arrangement with respect to other of said descriptors; and
arranging said representation in another dynamic hierarchical arrangement with respect to other representations.

10. The method of claim 1 wherein at least one of said descriptors includes a link to a content file that constitutes at least one of said multiple sources of content, wherein said representation is a tag.

11. The method of claim 1 wherein said descriptors include information indicative of a degree of relevancy for said content.

12. The method of claim 1 further comprises:
arranging said plurality of pools of content in a static hierarchical arrangement.

13. The method of claim 1 further comprises:
arranging said representation as a folder in a static hierarchical arrangement with respect to other representations as other folders; and
associating each of said descriptors with a file in said folder.

14. A method comprising:
generating for an interface:
a content panel configured to render content, and
an application navigation panel configured to navigate pools of content;
detecting selection of a pool of content within said application navigation panel;
subsequent to generating the content panel and the application navigation panel, forming an interstitial navigation panel in response to said selection of said pool of content, wherein said interstitial navigation panel is configured to directly switch said content within said content panel from said content to different content of said pool of content; and
in response to selection of another pool of content within said application navigation panel, reconfiguring said interstitial navigation panel to directly switch content within said content panel to different content of said another pool of content, wherein said reconfiguring is performed without changing the rendered content displayed in the content panel so that the same rendered content remains displayed in said content panel when said interstitial navigation panel is reconfigured.

15. The method of claim 14 wherein forming said interstitial navigation panel comprises presenting links to sources of content that constitute said pool of content.

16. The method of claim 14 wherein forming said interstitial navigation panel comprises:
detecting selection of a link associated with said pool of content; and
transitioning between different content in said content panel without generating an intervening panel.

17. The method of claim 14 further comprising:
presenting different content from a plurality of content from said pool of content in said content panel; and
maintaining said interstitial navigation panel and said application navigation panel during presenting said different content.

18. The method of claim 14 wherein forming said interstitial navigation panel comprises presenting descriptors relating to sources of content that constitute said pool of content, at least one of said descriptors comprising a representation indicative of a degree of relevancy for a source of content.

19. The method of claim 18 wherein said degree of relevancy includes a ranking

20. The method of claim 14 wherein generating said application navigation panel comprises:
presenting tags in at least a portion of said application navigation panel, said tags being ranked differently than other tags.

21. The method of claim 20 wherein detecting said selection of said pool of content comprises:
detecting selection of a tag to select said pool of content.

22. The method of claim 14 wherein generating said application navigation panel comprises:
presenting a search field configured to receive search criteria.

23. The method of claim 22 wherein detecting said selection of said pool of content comprises:
using said search criteria to select said pool of content.

24. A system comprising:
a memory configured to store data associated with portions of an interface; and
logic configured to:
render content from multiple sources of content in a first portion of an interface;
present a plurality of representations in a second portion of said interface for a plurality of pools of content, wherein each one of the plurality of representations represents a different respective one of the plurality of pools of content, wherein each one of the plurality of pools of content forms a subset of said multiple sources of said content, and wherein the plurality of pools of content are part of a hierarchy within a domain of a single website;
present descriptors in a third portion of said interface corresponding to a selected representation for a respective pool of content, wherein presenting said representation and said descriptors occurs substantially simultaneous to rendering of said content from said multiple sources; and
in response to selection in said second portion of another representation for another respective pool of content, replace said descriptors in said third portion with new descriptors corresponding to the selected another representation for the another respective pool of content, wherein the same rendered content remains displayed in said first portion when said descriptors are replaced with said new descriptors.

25. A system comprising:
a memory configured to store data associated with panels of an interface; and
a processor configured to generate for the interface:
a content panel configured to present content; and
an application navigation panel configured to navigate pools of content and to detect selection of a pool of content;
wherein said processor is further configured to:
subsequent to the generation of the content panel and the application navigation panel, form an interstitial navigation panel in response to said selection of said pool of content, wherein said interstitial navigation panel is configured to directly switch said content within said content panel from said content to different content; and
in response to selection of another pool of content within said application navigation panel, reconfigure said interstitial navigation panel to directly switch content within said content panel to different content of said another pool of content, wherein said reconfiguring is performed without changing the rendered content displayed in the content panel so that the same rendered content remains displayed in said content panel when said interstitial navigation panel is reconfigured.

26. A computer readable storage medium, wherein the computer readable storage medium is a memory, storage device or disk storing program instructions executable to:
render content from multiple sources of content in a first portion of an interface;
present a plurality of representations in a second portion of said interface for a plurality of pools of content, wherein each one of the plurality of representations represents a different respective one of the plurality of pools of content, wherein each one of the plurality of pools of content forms a subset of said multiple sources of said content, and wherein the plurality of pools of content are part of a hierarchy within a domain of a single website;
present descriptors in a third portion of said interface corresponding to a selected representation for a respective pool of content, wherein said presenting said representation and said descriptors occurs substantially simultaneous to rendering of said content from said multiple sources; and
in response to selection in said second portion of another representation for another respective pool of content, replace said descriptors in said third portion with new descriptors corresponding to the selected another representation for the another respective pool of content, wherein the same rendered content remains displayed in said first portion when said descriptors are replaced with said new descriptors.

27. A computer readable storage medium, wherein the computer readable storage medium is a memory, storage device or disk storing program instructions executable to:
generate for an interface:
a content panel configured to present content; and
an application navigation panel configured to navigate pools of content and to detect selection of a pool of content;
subsequent to the generation of the content panel and the application navigation panel, form an interstitial navigation panel in response to said selection of said pool of content, wherein said interstitial navigation panel is configured to directly switch said content within said content panel from said content to different content; and
in response to selection of another pool of content within said application navigation panel, reconfigure said interstitial navigation panel to directly switch content within said content panel to different content of said another pool of content, wherein said reconfiguring is performed without changing the rendered content displayed in the content panel so that the same rendered content remains displayed in said content panel when said interstitial navigation panel is reconfigured.
